(19) United States
(12) Patent Application Publication
(10) Pub. No.: US 2007/0067125 A1
(43) Pub. Date: Mar. 22, 2007

(54) Procedure of expertise of exhaustibility, of efficiency and of the feasibility of systems of traceability put in place on an industrial site, notably in the agro-food sector

(76) Inventors: Baptiste Guivarch, Acigne (FR); Lionel Guivarch, Noisy Le Roi (FR)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/521,064

(22) Filed: Sep. 14, 2006

Related U.S. Application Data
(60) Provisional application No. 60/717,099, filed on Sep. 14, 2005.

(51) Int. Cl. G06F 19/00

(52) U.S. Cl. 702/84; 700/109

(57) ABSTRACT

The disclosure relates to a method for inspection of the quality of products produced by a production system, by monitoring the exhaustiveness, effectiveness and reliability of a traceability system associated with said production system. The method includes the following steps: determination of a plurality of domains of said traceability system to be inspected; determination of a plurality of criteria to be monitored for each of said domains, said criteria for a domain being correlated to each other; for each of said criteria, assignment of a numerical data representing a quality value by measurement through at least one sensor and/or by assessment; for each of said domains, multiplication of all said numerical data for each said criterion in said domain and application of a mathematical regression function to the resulting product to obtain a numerical data representative of a quality value of said domain; comparison of said numerical data with at least one predetermined threshold for each of said domains.

### CROSS-REFERENCE TO RELATED APPLICATION

The present application is based on and claims the benefit of U.S. provisional patent application Ser. No. 60/717,099, filed Sep. 14, 2005, the content of which is hereby incorporated by reference in its entirety.

### FIELD OF THE INVENTION

The field of the disclosure is automatic monitoring or traceability of products in the industrial sector, and particularly in the farm-produce industry. More precisely, the disclosure relates to a method of expertise of the exhaustiveness, efficiency and reliability of the traceability system set up on an industrial production site.

### BACKGROUND OF THE INVENTION

Traceability is a management tool that is now unavoidable in the supply, risk and quality chain in a company. Obviously, the traceability system based on a chain of hierarchised information contributes to the logistics organisation and quality approach of the company, but also increasingly to its prospecting and commercial strategy.

The list of mainly industrial products for which the life path must be monitored according to legal or standard requirements, is continuously increasing throughout the world, particularly in Europe and in North America. This list of products still includes most products in the pharmaceutical or farm-produce sector at the moment. However, other sensitive products are referenced in it, including car seats and cushions, blood derivatives and tyres fitted on an automobile vehicle for which a unique identifier issued in cooperation between tyre manufacturers must be assigned, according to a recent legal decision in the USA.

Many food crises in the farm-produce sector, particularly in France and in Europe, caused by listeriosis, the presence of salmonella or dioxins, have shown the difficulty for operators in the farm-produce sector of controlling all risks associated with the life path of the food product.

It has also been noticed that when a defective product or a risk product has been detected at any step in its life path, it is very difficult to successfully, quickly and efficiently identify all other products that have at least partially been subjected to the same treatment as the defective product and that can have the same defect. For example in the case of a product contaminated by listeria, it is particularly important to be able to withdraw all other potentially contaminated products from sale quickly, so that they do not reach the consumer's plate. This safety challenge also applies to the automobile industry in the case of failures of important mechanical parts in braking or steering systems in a series of automobile vehicles, the radioactive waste treatment and storage industry, and the pharmaceutical field.

The introduction of genetically modified organisms (GMO) onto the consumer market and particularly onto the American market, the case of bovine spongiform encephalitis (BSE) that decimated European cattle farms, and the avian flue epidemic in Asia, increase the anxiety of consumers and have made all players in the farm-produce sector aware about the absolute need to set up an efficient and complete traceability system for food products including all information about the life of this product (creation, transformation, storage, etc.) and that is filled in every time that the product passes into a link of the production and distribution chain.

An increasing number of new regulatory obligations are the result of demand by companies and their economic fabric (customers, shareholders, bankers, suppliers, insurance companies, etc.) to increase security on risks related to the traceability process in the company. These laws, regulations, standards or principles of precaution are essentially related to food safety (for example European Regulation 178/2002 or “Bioterrorism preparedness Act & Country-of-origin Labelling law”) or financial management (for example the law on financial security or “Sarbanes Oxley Act”).

However, at the moment there is no effective and reliable method for assessment that can be used to qualify performance in terms of traceability of an industrial production site, particularly for food products, procurement at suppliers and distribution of manufactured products, regardless of the industrial sector involved (farm-produce, automobile, chemical, pharmaceutical products, telecommunications, etc.)

### SUMMARY OF THE INVENTION

An embodiment of the invention is directed to a method for inspection of the quality of products delivered by a production system, by monitoring the exhaustiveness, effectiveness and reliability of a traceability system associated with said production system.

According to an embodiment of the invention, such an inspection process includes the following steps:
determination of a plurality of domains of said traceability system to be inspected;
determination of a plurality of criteria to be monitored for each of said domains, said criteria for a domain being correlated to each other;
for each of the said criteria, assignment of a numerical data representing a quality value by measurement through at least one sensor and/or by assessment;
for each of said domains, multiplication of all said numerical data for each of said criteria of said domain and application of a mathematical regression function to the resulting product to obtain a numerical data representative of a quality value of said domain;
comparison of said numerical data with at least one predetermined threshold for each of said domains.

Thus, an embodiment of the invention is based on a quite new and inventive approach to check the exhaustiveness and quality of the traceability information on an industrial site. The technique used in an embodiment of the invention is based on a thorough technical expertise of the reliability, effectiveness, coverage and exhaustiveness of the traceability system used on this site, which had never been envisaged in the past. Such a technique is based particularly on a breakdown of the traceability system into a set of domains to be checked that are complementary to each other, and on determination of a plurality of criteria to be monitored that are correlated to each other, within each of these domains. This correlation enables simple and precise assignment of a numerical value to each domain, representing the quality level of this aspect of the traceability system, by multiplication of marks assigned to each of the criteria in this domain.

The result is thus an efficient tool for evaluating the quality of the traceability system which, in the case of a defect can directly control the production system stopping which provides significant improvement compared with previous systems in which the time that elapsed between detection of a defect on a product output from the industrial site and when all batches that could have the same defect were called back could be particularly long.

Thus, the reactivity of the company following a problem is guaranteed by use of an embodiment of the invention through regular updating of traceability information.

Furthermore this tool can reduce the number and the range of products to be called back following an incident, particularly on a food product, if information related to batch numbers has not been recorded and/or kept. An embodiment of the invention makes targeted identification of the products concerned possible.

Advantageously, such an inspection method also includes a step in which a graphic representation of said numerical data is generated for each of said domains in the form of a rosette.

Preferably, said regression function is chosen such that said predetermined threshold coincides with the mid-point of a corresponding branch of said rosette.

Thus, the enterprise has a tool for directly displaying the performances of its traceability system.

According to one advantageous technique according to an embodiment of the invention, such a control method also includes a step to compare said generated rosette with a minimum predetermined rosette and, depending on the result of said comparison, a step to issue a certification label for said traceability system.

The certification label could thus be generalised to include a set of sites or enterprises and an up to date communication of referenced sites to the public through various media (web, etc.) for better consumer information.

The company also has a retroactive control tool for its industrial site. After becoming familiar with the rosette, persons involved in the site can then take the necessary measures to restore performances of the traceability system.

Preferably, said domains of said traceability system belong to the group comprising:
quality of information necessary to produce a complete map-making of the activity of said production system;
exhaustiveness of information related to said traceability system;
matching of said traceability system and operating processes of said production system;
assessment of the reliability of said traceability system;
coding of said products conforming with at least one coding standard applicable to said production system;
availability of information and products;
matching of said traceability system and at least one risk management use related to an activity sector of said production system;
extension of said traceability system outside said production system within an activity-network scope;
setting up in said production system of at least one traceability procedure and at least one training plan in said procedure for said production system personnel.

Thus, an exhaustive collection is made of all information necessary to evaluate the performances of the traceability system for an industrial site.

According to one advantageous characteristic of an embodiment of the invention, said step to assign a numerical data to each of said criteria is done following a matrix analysis of said traceability system, and said numerical data assigned to each of said criteria is a value in a set of four predetermined numerical constants depending on whether said criterion is:
conforming with a predetermined reference criterion;
not conforming with said predetermined reference criterion and with high importance;
not conforming with said predetermined reference criterion and with moderate importance;
not conforming with said predetermined reference criterion and with low importance.

Thus, the person in the enterprise responsible for improving the traceability system has a hierarchical analysis of potential actions to be undertaken in the framework of the traceability activity. The application according to an embodiment of the invention thus provides valuable aid in the decision making process.

Preferably, said numerical constants are within the set (1; 0.01; 0.7; 0.9).

According to one advantageous technique of an embodiment of the invention, for a domain said predetermined threshold S, is defined by S=ƒ_{p,q}(β^{p}γ^{q}), where p is the number of criteria with moderate importance in said domain, q is the number of criteria with low importance in said domain, ƒ_{p,q} is said mathematical regression function, β is the value of the numerical data assigned to a moderate importance criterion and γ is the value of the numerical data assigned to a low importance criterion.

Advantageously, where α is the value of the numerical data assigned to a high importance criterion, the highest numerical value such that 0<α<β<γ<1 and α<β^{p}γ^{q} for all values β and γ is assigned to α.

In one advantageous embodiment of the invention, application of said mathematical regression function ƒ_{p,q} to 1 corresponds to a predetermined scale factor, and to β^{p}γ^{q} corresponds 1 to half of said scale factor.

Preferably, said scale factor is equal to approximately 100.

Advantageously, only high importance criteria are considered during said comparison step between said generated rosette and a predetermined minimum rosette.

The expectations and constraints of the different industrial players will be different depending particularly on their activity sectors and the size of the site. Therefore it is important that they should have a reliable and immediately available indicator that respects their specific needs.

An embodiment of the invention also relates to a quality control system for products produced by a production system by monitoring the exhaustiveness, effectiveness and reliability of a traceability system associated with said production system, including means of:
determining a plurality of domains of said traceability system to be controlled;
determining a plurality of criteria to be monitored for each of said domains, said criteria for a domain being correlated to each other;
for each of said criteria, assignment of a numerical data representing a quality value by measurement through at least one sensor and/or by assessment;
for each of said domains, multiplication of all numerical data for each of said criteria in said domain and application of a mathematical regression function to the resulting product to obtain a numerical data representing a quality value for said domain;
for each said domain, comparison of said numerical data with at least one predetermined threshold.

Similarly, an embodiment of the invention covers downloadable computer software that can be downloaded from a communication network and/or stored on a medium that can be read by computer and/or executed by a microprocessor, including program code instructions for use of steps in above-mentioned the product quality control method.

Other characteristics and advantages will become clearer after reading the following description of a preferred embodiment given as a simple illustrative and non-limitative example, and the appended drawings.

### BRIEF DESCRIPTION OF THE DRAWINGS

FIG. 1 shows a block diagram of the characteristics and the organisation of physical flows and the traceability system for an industrial reference site in its environment;

FIG. 2 describes the organisation of characteristic criteria for an embodiment of the invention;

FIGS. 3A and 3B show calculation algorithms for values associated with each theme and values used to estimate assignment of a certification, respectively;

FIG. 4A shows a breakdown of each individual step in the entire flour milling activity on an industrial bakery site, and FIGS. 4B to 4E show details of the organisation of collection and processing of traceability information in this context within raw material reception and addition sub-processes, and also the kneading, filling and on-site palletising sub-processes;

FIG. 5 shows an embodiment of the invention starting from criteria for the assessment of the exhaustiveness of information in the traceability system for an industrial bakery site;

FIG. 6 shows a graphic view of the expertise according to an embodiment of the invention for an industrial site in the form of a rosette.

### DETAILED DESCRIPTION OF ILLUSTRATIVE EMBODIMENTS

The general principle of an embodiment of the invention is based on the use of an effective and reliable expert method for measuring the exhaustiveness, effectiveness and reliability of a traceability system adapted to any industrial site.

This innovative method is based on a matrix analysis of the traceability activity of the site, taking account of tracing actions associated with elementary production sub-processes, and the procedure related to quality control, and logistics monitoring.

The inventors have defined the characteristics of a typical or “standard” site reference tool, so that the method according to an embodiment of the invention can be applied to any industrial site. A so-called “standard” site has all the general characteristics of a production site, without exception, and has a traceability system that is ideally organised and therefore is faultless at all levels.

A traceability system is ideally organised about four principal operational themes:
management of information that is unlikely to change in the short or medium term related to flows of products or sub-products, organisation of production, tracing of materials, the system set up for identification of products and tracing of information, the system for management of links between product identifiers;
management of traceability operations that must be coordinated with production in the long term and that relates to input of information, dynamic capture of links, archiving of information, security of information and information access control;
management of the information system;
management of identified risks.

Furthermore, such a traceability system can be adapted to fast changes in production schemes.

The exhaustiveness and performances of the traceability system are then measured using a framework of criteria organised around nine themes, also called domains. For satisfactory use of the method, a preliminary enquiry in the form of a questionnaire must be carried out with qualified personnel on the site so as to collect unambiguous answers that do or do not validate or partially validate the criteria.

A specific algorithm for processing of all criteria is used to quantify the quality of the traceability system set up on the site to be evaluated, in comparison with the “standard” site.

The breakdown into nine themes provides a means of identifying the most critical measures to be implemented, to plan for the cost of work and to plan a calendar. In this sense, an embodiment of the invention is a technical decision making tool. One natural improvement to an embodiment of the invention could be to use it as a label assignment tool to solve this problem.

Furthermore, an embodiment of the invention can be used to hierarchise the site on the scale of a network, so as to participate in estimating the economic cost effectiveness of the site and reducing operating costs.

Furthermore, one application of an embodiment of the invention includes installing an indicating screen on the site so as to display and control the daily variation of the performance of the traceability system starting from assessment parameters defined according to an embodiment of the invention.

The criteria are formed on a single model and belong to the group of questions designed to satisfy two questions in the following form:
Is there an action, procedure, document, information about the document, information in a precise format about the document, kept on the industrial site?
Has the company set up a procedure, a systematic action?

The answers to these questions are analysed to determine whether or not the criterion is fully conforming. If the question applies to a set of processes, procedures or actions that can be identified, a criterion satisfied only by part of this set is considered as being nonconforming.

Also, with the technique according to an embodiment of the invention, a degree of importance, more generally called importance, is assigned to each criterion, and this importance can be considered as being high, moderate or low.

Thus, an embodiment of the invention is based on an approach to the management of traceability procedures that is quite new and complete. An embodiment of the invention provides professionals with a tool for expertise of the traceability system that is high performance because it is easy to implement.

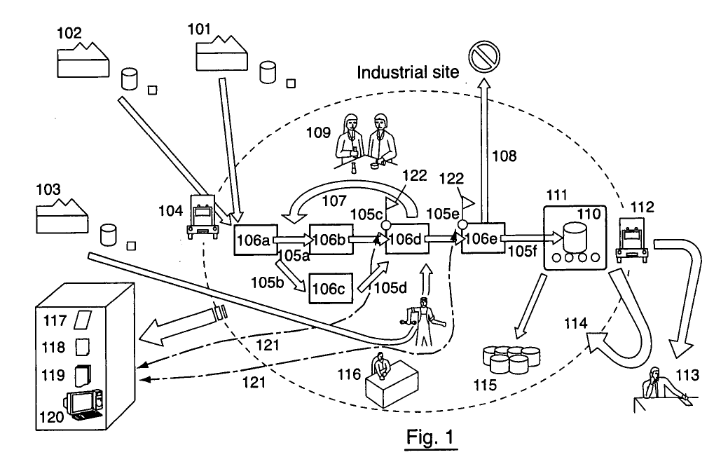

A block diagram of the characteristics and organisation of physical flows and the traceability system for a reference industrial site in its environment is shown with reference to FIG. 1.

The upstream organisation of the site includes suppliers of raw materials 101, manufactured materials 102 and consumables (maintenance and servicing products, etc.) 103, and the logistics transport 104 of these products to the production site. Physical flows 105a to 105f of materials (from one station to another, transformation or assimilation of a material) on the site are directed in accordance with the order of the manufacturing steps 106a to 106e and interfere with the recycling step 107 or the transfer to scrap step 108. Analyses are made from material samples taken from the production line on site or in laboratories 109. The finished product 110 is wrapped and/or packaged by a dedicated unit 111 before it is taken off site so as to be transported (transporter 112) to the distribution or production sites of customers 113. Returned products 114 or the stock of unsold products 115 are managed by the logistics unit 116.

The traceability system is deployed at all levels and is based on information supports such as vouchers or datasheets 117, labels 118, the traceability-quality file 119 that contains all information related to the traceability chain and quality analyses carried out on the raw materials, partly finished products or finished products, and computer means 120 for management and archiving of traceability-related data.

For a standard site, all actions on products (change location, unusual events (failures, etc.) or malfunctions) are recorded on these supports so as to build up an exhaustive and secure information system.

Biunique links 121 represented by double arrows, denote self checking operations on critical points that are represented by flags 122. These operations, combined with a systematic document conservation procedure on different media and appropriate security measures, assure faultless reliability of the traceability system.

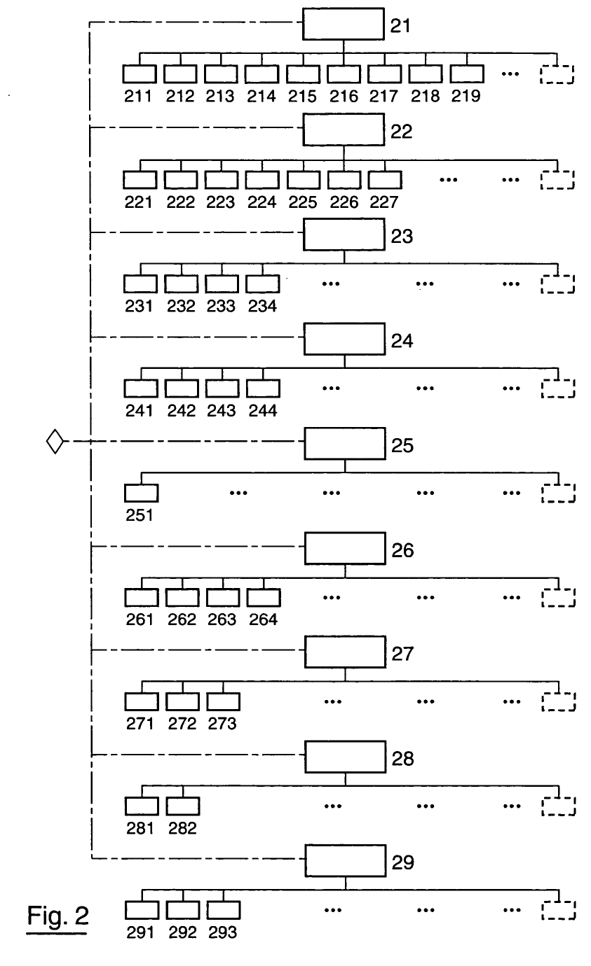

FIG. 2 shows the organisation of characteristic criteria of an embodiment of the invention around nine themes forming domains of the traceability system that should be monitored.

Theme 21 encompasses criteria related to all information necessary to build up the complete map-making of site activity:
criterion 211 aims to verify that there is a map (block diagram, complete and functional) listing manufacturing procedures and including at least steps in the procedures and their duration, food and non food raw materials, intermediate products and the finished product, recycled products, waste, consumer units, packaging and dispatching units;
criterion 212 aims to determine if there is a map of the traceability device both on the upstream side of the production site (relations with the supplier), on the production site and on the downstream side of the site (delivery to the customer) that includes at least a description of functional steps and batches including the definition of all products concerned, the step(s) preceding their creation, the affiliation link of one batch with parent and children batches and specifying identifiers, coding and hardware support and the corresponding location;
criterion 213 aims to determine if there is a description of the contents of traceability-quality files by type of finished product, including all physicochemical and microbiological analyses carried out on the finished product and materials used in manufacturing of the finished product;
criterion 214 aims to verify if there is a document explaining operation for building up all batches associated with production of a finished product;
criterion 215 aims to verify if there is a map of computer tools and marking and reading instruments used;
criterion 216 aims to verify if there are specifications on operation of the traceability in computer systems;
criterion 217 aims to verify if there is a description of the traceability device in terms of sub-processes for each step that includes at least information related to:
   batch number generation inputs and outputs;
   means of capturing batch numbers (barcode, radiofrequency identification (RFID), paper input, label, electronic data interface (EDI) protocol, electronic mail, fax, telephone, etc.):
   computer applications or paper documents containing the information;
   processing and checks;
   data transmissions;
   profiles of persons authorised to input;
   authorisation means (access rights);
   the input location;
   the storage location;
   the time of storage;
   the time of use in reproduction of information (traceability request);
   the person responsible for storage;
   authorisation means (access rights, physical safety, interlocking mechanism);
   the event that triggers the input.
criterion 218 aims to verify if there are any hazard assessment means and self checking measures on the traceability process using “Hazard assessment for the control of critical points” or HACCP type methods;
criterion 219 aims to verify if there is a list of suppliers classified by product nature, a list of finished products sorted by best before or consumption duration or life, a list of customers sorted by product and a list of contractual customer requirements on the traceability part.

The theme 22 contains criteria related to the exhaustiveness of information related to the traceability process:
criterion 221 aims to verify if supplier reception vouchers/delivery vouchers addressed to customers contain information about identification of the supplier/customer, the nature of products, and the transaction/delivery date that must be available to the competent authorities;
criterion 222 aims to determine if supplier reception vouchers/delivery vouchers addressed to customers contain information about more detailed information to be kept on products, quantities and batch numbers;
criterion 223 aims to verify if supplier reception vouchers/delivery vouchers addressed to customers contain information about transporters;
criterion 224 aims to determine if there is a record at manufacturing level of information about raw materials, primary or incorporated processed materials (PPM or IPM), products being manufactured, manufacturing steps, manufacturing problems;
criterion 225 aims to verify if the company assures traceability of recycled products;
criterion 226 aims to verify if the company assures traceability of co-products and reconditioned products;
criterion 227 aims to determine if the company records information about the dispatching: date, customer, address, product name, code, date of minimum durability (DMDP) for products, use before date (UBD), quantity, manufacturing date, pallet batch number, transporters, truck number.

Theme 23 contains criteria related to how the traceability system matches the operating process. The company must check consistency between traceability information reproduced by the traceability system and the manufacturing procedure or “process” and particularly:
criterion 231 aims to verify if the existing traceability system takes account of manufacturing problems (failure, restart of production), material recycling during the “process”, cleaning dates of equipment and machines for delimiting the batch recall perimeter, built-up shipment units, operations to replace boxes on pallets, returns of unsold products, co-products, operations to put products back into the “process” due to a bagging fault;
criterion 232 aims to verify if the traceability-quality file contains analysis certificates on raw materials and finished or partly finished products, water analysis certificates, inspection sheets, maintenance and cleaning documents;
criterion 233 aims to determine if there is synchronisation between the information flow and the physical flow of products;
criterion 234 aims to determine if the company assures that the traceability system is consistent and particularly that identifiers or batch numbers are actually unique, that identification of parents or children batches is unambiguous, that there is a biunique correspondence between documents in the traceability-quality file and the related entity through the batch number or other information, that traced entities or batches are composed of products for which production and/or transport conditions are identical, that the uniqueness of the Serial Shipping Container Code (SSCC) is guaranteed, that recording of the unambiguous affiliation of dispatching units is assured in the case of multiple procurement points in a just-in-time flow management (picking) or assemblies composed of heterogeneous units.

Theme 24 includes criteria participating in the assessment of the reliability of traceability procedures:
criterion 241 aims to determine if there are any efficient procedures related to the existing self checking for critical points related to capture, modification and reproduction of batch numbers and links between batch numbers, particularly related to management of incidents, input errors and retrieval through computer interfacing of raw material batch numbers, and the lack of a batch number on reception of the raw material;
criterion 242 aims to verify if there are efficient labelling procedures and particularly if logistics labels and particularly labels produced according to standards of the EAN (European Article Numbering) and UCC (Uniform Code Council) associations are correctly affixed and if pre-printed labels on the raw material are conforming;
criterion 243 aims to determine if there are any procedures for definition and checking of access rights to documents and computer systems;
criterion 244 aims to determine if the specification specifying methods of conversion, protection of data transfers between software includes a description of technical standards in force, mutual responsibilities of software in terms of data losses, the data protection device and particularly the interlocking system for sensitive information and special checks (cryptographic keys, etc.).

Theme 25 contains criteria related to coding of products according to standards and particularly:
criterion 251 aims to verify if the EAN and EAN UCC standards are used for labelling of logistics units (pallets, boxes), identification of the main functional locations, and coding of the raw materials and incoming products to be traced.

Theme 26 contains criteria related to availability of information and products:
criterion 261 aims to determine if the company performs a computer media test by simulation of a restore operation;
criterion 262 aims to verify if the enterprise performs a double measurement of the duration necessary to collect or identify finished products in the chronological order in which the product is produced, carrying out a search operation for a set of products packaged on a pallet starting from their batch number, and internal batch numbers of finished products starting from a raw material batch number or a packaging material batch number;
criterion 263 aims to determine if the company performs a double measurement of the duration necessary to collect or identify finished products in inverse chronological order from the order in which the product is produced, by carrying out an identification or recovery operation of raw materials used starting from a finished product batch number, all “documentation mapping” information and all supplier batch numbers and internal raw material batch numbers concerned starting from a raw material batch number;
criterion 264 aims to determine if the company assures that the conservation time for each information type is greater than the life or the date of minimum durability (DMDP) of products, in accordance with the legislation or legal recommendations.

Theme 27 includes criteria related to matching of the traceability system with risk assessment factors used in the activity sector of the site, and particularly:
criterion 271 aims to determine if the company has estimated withdrawal costs following a problem detected on a raw material batch from a supplier or internally;
criterion 272 aims to verify if the fineness of the traceability procedure is consistent with food risks at each traceability node;
criterion 273 aims to determine if the company has taken account of the allergen risk and the risk related to the presence of GMO.

Obviously, criteria 272 and 273 are only relevant for the farm-produce industry.

Theme 28 includes criteria related to extension of the traceability system off site within the scope of the activity:
criterion 281 aims to determine if the enterprise assures that suppliers comply with a quality assurance plan that it has approved by ordering an annual audit, by verification or isolated inspection of logistics traceability parameters, by assuring that contracts with suppliers of materials used for manufacturing the product and providing the service contain information specifying:
   the name of the raw material;
   the batch number (formation procedure, coding) and its location on the product and accompanying documents;
   definition of the batch (content, quantities);
   archiving and access conditions to the accompanying document;
   intervals between traceability tests.
criterion 282 aims to determine if the material supplier contract includes the manufacturing “process” diagram and the accompanying document.

Theme 29 includes criteria related to setting up of traceability procedures and the training plan for personnel in use of these procedures and particularly:
criterion 291 aims to verify if there is a traceability action at each step of the manufacturing or packaging procedure;
criterion 292 aims to determine if there are any self-checking procedures for each critical point and particularly for:
   i. labelling raw materials/processed materials and EAN UCC logistic re-labelling following an incident;
   ii. use of in bulk raw materials;
   iii. recycling of products during manufacture;
   iv. signalling of a malfunction and management of incidents (the restore and restart procedure following an error in manufacturing of the product) and/or in the case of a software failure;
   v. management of a product call back;
   vi. management of end of batches, return of unsold products, waste, unsold products and withdrawals;
   vii. appointment, designation or information feedback from personnel and/or external persons (audit) and/or suppliers and/or customers in the traceability-quality activity;
   viii. archiving.
criterion 293 aims to determine if there is a training plan aimed at all personnel on site during introduction of new software or marking equipment and/or reading equipment, and introduction of a plan dedicated to other novelties aimed at handling or logistics personnel.

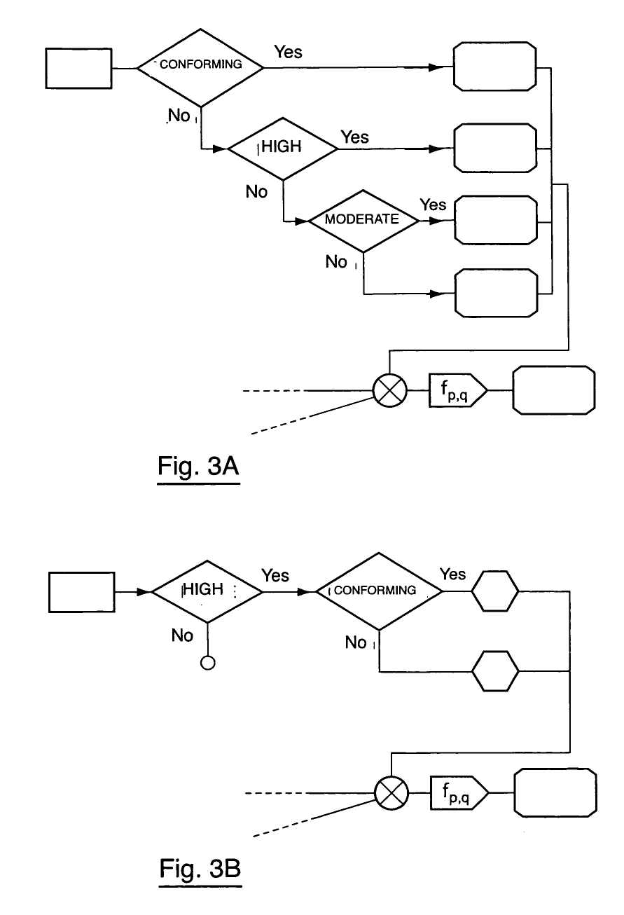

Note that the degree of importance, also called importance, assigned to all the previous characteristic criteria related to themes 21 to 29, is high. FIG. 3A shows the calculation algorithm used to assign a global value 301 for each theme, to evaluate the degree of perfection or imperfection of the traceability system. The algorithm assigns the constant 320 to each conforming criterion 310, and conversely assigns a constant α 330, β 340 or γ 350 depending on whether the degree of importance of the criterion is high, moderate or low respectively, if the criterion 310 is not conforming. The value of the constants α 330, β 340 or γ 350 is attached to each of the themes, and can thus be different for two different themes. Note that in most situations in which an embodiment of the invention is used, the value of the constants α 330, β 340 and γ 350 actually remains unchanged for all themes.

For each theme, a plurality of additional criteria may be added to the characteristic criteria described in an embodiment of the invention, under the express condition that these criteria have an incidence correlated to the incidence of characteristic criteria within this theme.

In one preferred embodiment of the invention, the constant 320 is equal to 1, and the results of studies have shown that the constants α 330, β 340 and γ 350 should be equal to the values of one hundredth, seven tenths and nine tenths respectively.

More generally, the technique according to an embodiment of the invention recommends that the constants α 330, β 340 and γ 350 should be chosen for a theme such that:
the constants α 330, γ 340 and γ 350 are strictly between zero and one, and the constant γ 350 is strictly greater than constant β 340, itself strictly greater than the constant α 330.
the constant α 330 remains less than the product of any constant β 340 to the power p and any constant γ 350 to the power q, where p and q are equal to the total number of criteria with moderate and low degrees of importance for this theme.

The global value 301 is the numerical image through a mathematical function ƒ_{p,q} of the value obtained by forming the product of the set of constants (320 or 330 or 340 or 350) assigned to each criterion. The mathematical function ƒ_{p,q} dependant on the pair (p,q) for each theme may be a linear, polynomial, logarithmic or exponential regression defined such that application of ƒ_{p,q} at 1 corresponds to a value 360 also called the scale factor, and application of ƒ_{p,q} at β^{p}γ^{q} corresponds to half of this value 360. The value 360 in this preferred embodiment of the invention is equal to one hundred.

In a second embodiment of the invention, the criteria 221, 222 and 223 (renamed 221₃, 222₃, 223₃ respectively) apply exclusively to reception vouchers, an additional criterion 228 includes the characteristics of these same criteria for delivery forms only and criterion 224 is broken down according to four distinct criteria applicable to saving of:
information about raw materials and primary processed materials (criterion 224₁);
information about products being manufactured (criterion 224₂);
manufacturing steps (criterion 224₃),
manufacturing problems (criterion 224₄).

In this same embodiment, criterion 226 is replaced by two criteria 226₁ and 226₂, such that criterion 226₁ exclusively relates to traceability of by-products and criterion 226₂ relates exclusively to traceability of repackaging.

In this second embodiment, the degree of importance of criteria 221₃, 224₁, 224₂, 224₃, 224₄, 226₁ and 228 is high, the degree of importance of criteria 222₃ and 226₂ is moderate and the degree of importance of criteria 223₃ is low.

In a third embodiment, the criterion 241 is broken down according to four new criteria 241₁, 241₂, 241₃ and 241₄ aimed at determining if there are any efficient and reliable self checking procedures related to risk management for each batch number uniquely assigned during manufacturing procedure. These criteria apply to risks related to capture of information (criterion 241₁), risks related to reproduction of information (criterion 241₂), risks related to modification and/or deletion of information (criterion 241₃) and risks related to identification of links between two batches, respectively. In this third embodiment, criteria 241₁, 241₂ and 241₄ are of high importance and criterion 241₃ is of moderate importance.

Obviously, an embodiment of the invention also relates to any other embodiment using a breakdown of criteria listed as sub-criteria for the preferred embodiment, for which the degree of importance may be weighted with respect to the initial criterion to take account of specific features of the site, the activity sector, customers or suppliers.

In a fourth embodiment of the invention, a second value 302 justifies assignment of the traceability certificate and the consumer label, if it reaches a threshold value 303 for each theme. This value 302, for which the assignment method is shown in FIG. 3B, is calculated based solely on criteria with a high degree of importance. It is obtained forming the image by the function ƒ_{p,q} of the numerical result of multiplying all values in the set of constants (320 or 330) obtained for each criterion with a high degree of importance.

Furthermore, with the technique according to an embodiment of the invention, the value 303 corresponds to the image by the function ƒ_{p,q} of the product of (β)^{p} with (γ)^{q}, where p and q denote the total number of criteria with moderate and low degrees of importance respectively for the theme concerned.

We will now present an application of an embodiment of the invention to an industrial bakery site for manufacturing of bread intended for the production of sandwiches in fast food outlets.

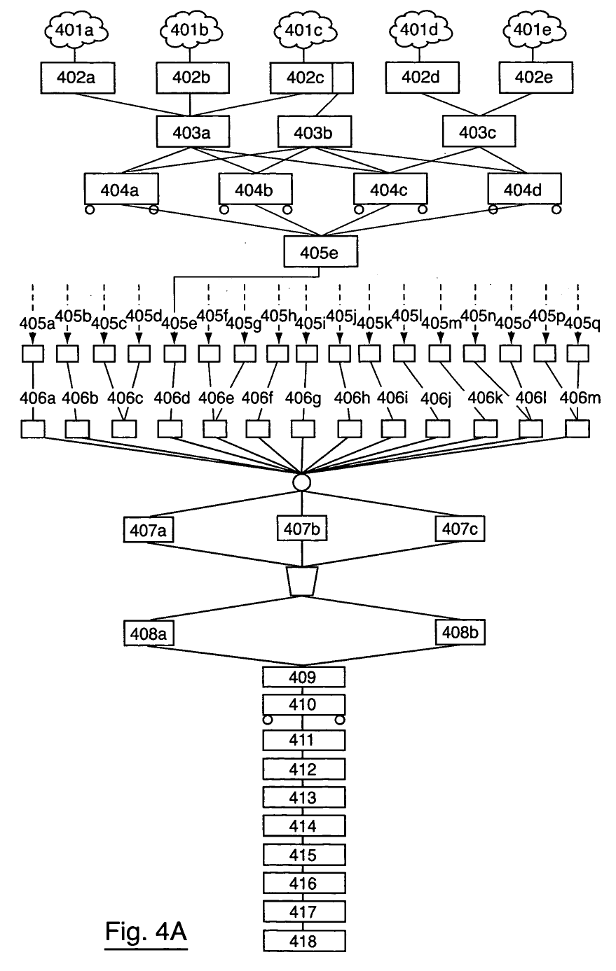

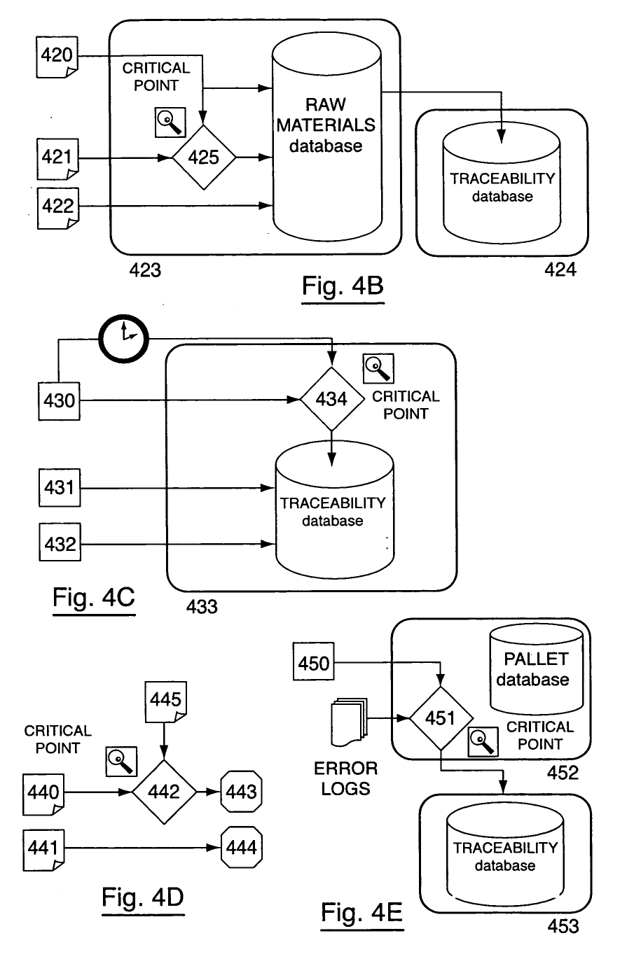

FIG. 4A shows a breakdown into sub-processes of prior raw materials preparation steps from wheat reception to the delivery of flour to the production facility, called the flour mill steps, for an industrial bakery product production site, in the form of a block diagram. Remember that this operation is necessary to accurately determine the performances of the traceability system for themes 21 to 24.

Remember also that in the general sense, a process is defined as being a chain of manual, semi-automatic and automatic tasks contributing to creation, production or processing of information, products or services. According to an embodiment of the invention, only processes that make a direct or indirect contribution to the production of logistic or qualitative aspects of traceability information are of course considered. In practice, a sub-process is associated with each manufacturing step (work on the material, change batch number).

In a first step, wheat is delivered by five farmers-suppliers to the site reception platform and then stored in five specific silos. Reception and storage operations for each of these raw material sources are referenced by sub-processes 401a to 401e and 402a to 403e respectively.

After reception of an order directive, wheat is transferred to secondary transit silos. The content of silos 402a, 402b and part of silo 403c are grouped in a first secondary silo according to sub-process 403a, the other part of silo 403c is transferred to a second secondary silo according to sub-process 403b and the content of silos 402d and 402e is grouped in a third secondary silo during sub-process 403c. Wheat in the secondary silos is then distributed onto four wagons according to processes 404a to 404d and transported in convoy to the mill during sub-process 405a.

In a second step, wheat is unloaded to a silo according to sub-process 406a. Other wheat quantities from other procurement sources follow a process identical to that used in the first step and are stored in other silos close to the mill during sub-processes 406b to 406m before passing into a central mixer (sub-process 407) supplied by all silos. The mix precedes the milling operation of wheat or sub-process 408. The flour obtained is then distributed in two storage silos during sub-processes 408a and 408b. A co-product called bran is obtained at the end of this process and is packaged to be sold as being a food complement for farm animals. The order reception sub-process 409 and the transport to the factory sub-process 410 then follow.

The next steps relate to manufacturing processes in the factory, although these are not described in detail; they include the addition of bulk and palletised raw materials to form the dough 411, kneading 412, first rising step 413 in which the dough is left to stand, forming 414, baking 415, coating 416, bagging 417, palletising 418.

FIGS. 4B to 4E show details of the organisation of collection and processing of traceability information within sub-processes 411, 412, 416 and 418.

Three items of information 420, 421, 422 are input in sub-process 411 (FIG. 4B) at the raw materials management application 423 before being exported to the traceability database management application 424 (traceability-quality file and corresponding computer application).

The items of information 420 and 421 correspond to the wheat flour batch number written on the supplier's delivery form to be used for stock management, and to the same wheat flour batch number that will be transmitted to the kneading sub-process 412 respectively, and shown in detail in FIG. 4C. The information 422 relates to the lack of GMO written on the soya flour analysis certificate.

Application 423 executes an operation 425 to check the wheat flour batch number input while kneading compared with the list of batch numbers input in logistics. This latter operation is the critical point attached to the sub-process 411, for which a self checking procedure was set up by the management software to check that the assigned batch number is unique and that the batch number input while kneading is conforming.

In sub-process 412 (FIG. 4C), three items of information 430, 431 and 432 are input in the traceability management application 433. The information 430 relates to the kneading operation start time read on the kneading machine clock and information 431 corresponds to reading the number of the silos (431) containing wheat flour, soya flour and sugar on a logic controller screen, and information 432 corresponds to reading the numbers of the tanks (432) containing yeast and oil, read on a second logic controller screen. Information 430 is processed and validated by software dedicated to application 433. The critical point attached to this sub-process is control of the chronology of times 430 indicated for each kneading sequence compared with the numbers of the batches concerned and the global synchronisation check of clocks on the site related to the manufacturing process or internal to the computer equipment. The company has set up a self checking procedure 434 related to this critical point.

The sub-process 416 (FIG. 4D) attached to coating the bread surface with sesame grains includes two input operations 440 and 441, a check operation 442 and two validation operations 443 and 444 as shown in FIG. 4D. Information 440 relates to the batch number of sesame bags marked on the supplier's delivery form and information 441 corresponds to the usage time of a sesame batch that is read on a specific clock. The operation 442 for checking correspondence between sesame batch numbers entered onto the supplier's delivery form and the “baker”'s reception form on which the sesame batch number is input by a baker's operator has been identified as being a critical point for this sub-process. A first automatic control procedure in the accounting department checks that each sesame batch number is conforming by comparing the supplier's delivery form with the “baker's” reception form, and a second automatic check procedure verifies that each batch number is unique by analysing accounting information related to the source of the sesame batch with the previous and the next batch numbers. Information 440 and 441 is then validated and recorded on a computer medium in operations 443 and 444.

Input information 450, processed information 451, and information exported to the database 452 in the sub-process 418 is shown diagrammatically in FIG. 4E.

Information 450 relates to the pallet number assigned automatically during creation of a new pallet and transmitted to the computer database dedicated to pallet management 452 to be exported to the traceability computer management database 453. An analysis of error logs output during the database export procedure 451 is done systematically to detect non-unique batch numbers. Secondly, a self-checking procedure is validated when the software designed for management of databases 452 and 453 is installed. This procedure consists of verifying that it is impossible for the event consisting of the generation of two labels with the same batch number to occur and that test data are correctly exported between the computer database dedicated to pallet management 452 and the traceability computer management database 453.

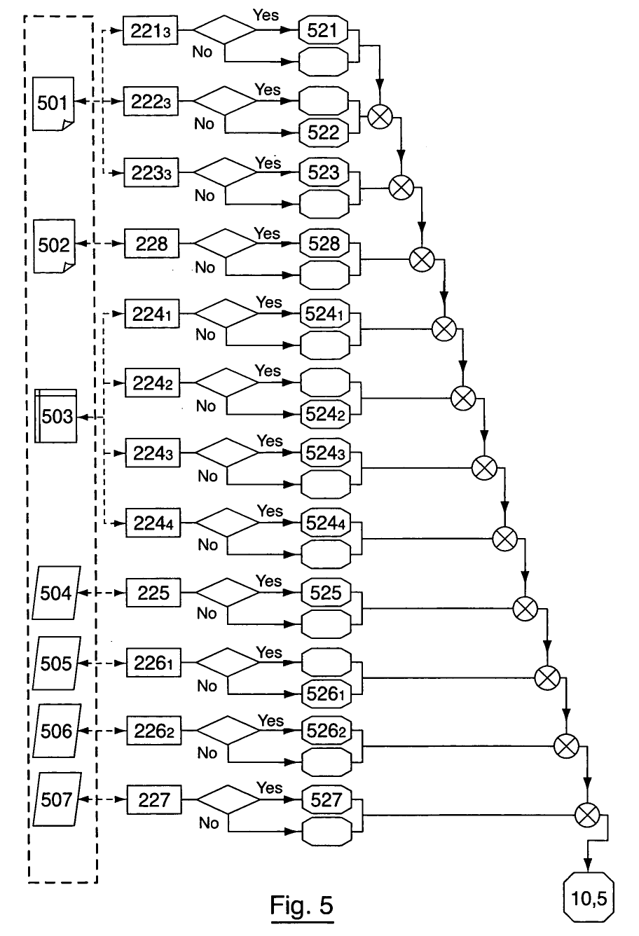

FIG. 5 shows a second embodiment starting from the theme related to criteria for assessment of the exhaustiveness of information for the industrial bakery site.

On the site, the management responsible for traceability activities has sent a questionnaire to competent personnel that it uses to collect information about the content of reception vouchers 501, delivery vouchers 502, documents related to monitoring of manufacturing 503 and recycled products 504, sheets marked with co-products 505 and product reconditioning 506, and documents related to shipment of products 507. This management will then be able to evaluate the performance of its traceability system concerning exhaustiveness of the information. To achieve this, it applies criteria 221 to 228 according to an embodiment of the invention. Management observes that the reception vouchers 501 do not mention the batch number of suppliers who delivered their production in bulk without specifying the origin of the crop areas. Management decides that criteria 221₃ and 223₃ are conforming and that criterion 222₃ is not conforming and associates the values 320, 340 and 320 with values 521, 522, 523 respectively, because the criterion 222₃ is of moderate importance.

Management then studies the questionnaire and observes that all information available on delivery forms 502 and related to criterion 228 is conforming, and therefore assigns the value 320 to the result 528. It also observes that information related to batch numbers used in the kneading step 412 does not appear on the manufacturing monitoring document 503. The values 320, 330, 320 and 320 are assigned to the numerical data 524₁, 524₂, 524₃ and 524₄, and therefore the product of the four previous values is assigned to the global value 524 corresponding to the criterion 224. Furthermore, responses to the questionnaire indicate that recycled products are traced and therefore the value 320 is assigned to the numerical data 525 in accordance with criterion 225.

Management uses the questionnaire to validate that reconditioned products are traced and that on the other hand, excess dough remaining stuck to the tank is not put back into the dough during the forming and cutting step, but is used to make by products. Values 330 and 320 are thus assigned to data 526₁ and 526₂. Furthermore, since the dispatching documents contain all information required by criterion 227, then the value 320 is assigned to data 527.

Remember that in the preferred embodiment, the coefficients equal to one hundredth, seven tenths and nine tenths are assigned to the values α 330, β 340 and γ 350 and the value of the coefficient 360 is one hundred. The result of the assessment is ten and a half (10.5) for the information exhaustiveness theme, with reference to a standard site for which the result is equal to one hundred, which is therefore not very good. Details of nonconforming criteria also guide the measure decision process towards the most appropriate measures to be taken to improve collection of traceability information.

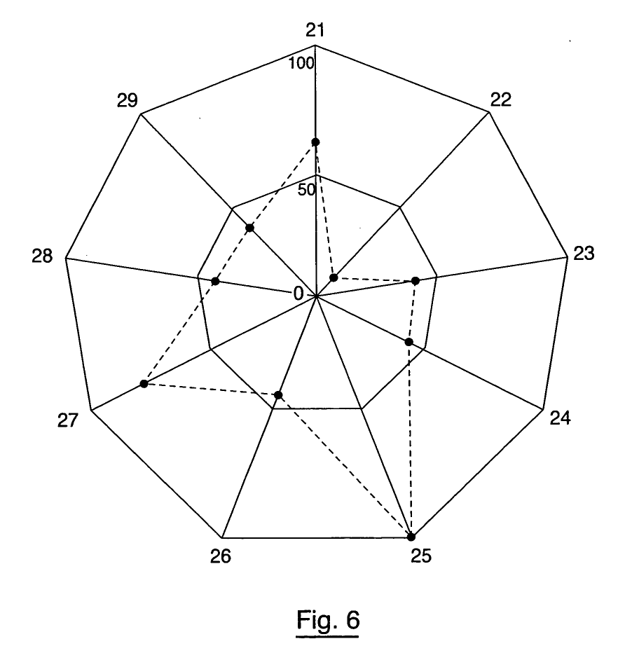

We will now present a graphic view of the result of the expertise on the traceability system according to an embodiment of the invention in the form of a rosette, with reference to FIG. 6. The rosette includes nine branches corresponding to characteristic themes 21 to 29, graduated on a scale from zero to one hundred.

This presentation advantageously enables synthetic monitoring of the traceability system. To improve readability, the condition for assignment of the label is set equal to one half of the value of 360 for each theme, such that this condition coincides with a regular nonagon. The values 302 resulting from the assessment of the performance of each theme, are marked on each branch of the rosette and are connected by a curve shown in dashed lines. For the embodiment shown in FIG. 6, the function ƒ_{p,q} associated with a branch of the rosette is a linear regression that associates the result ƒ_{p,q} (X)=(value 360) (x/(2(1−β^{p}γ^{q}))+(β^{p}γ^{q}−½)(β^{p}γ^{q}−1)) with any variable x.

One or more of methods or method steps described above can be embodied in a computer software program can be downloaded from a communication network and/or stored on a medium that can be read by computer and/or executed by a microprocessor. The computer software includes program code instructions for performing the method or method steps. An embodiment of the present invention is directed to a computer-readable medium having computer-executable instructions for performing the method comprising:
determination of a plurality of domains of said traceability system to be inspected;
determination of a plurality of criteria to be monitored for each of said domains, said criteria for a domain being correlated to each other;
for each of said criteria, assignment of a numerical data representing a quality value by measurement through at least one sensor and/or by assessment;
for each of said domains, multiplication of all said numerical data for each of said criteria of said domain and application of a mathematical regression function to the resulting product to obtain a numerical data representative of a quality value of said domain; and
comparison of said numerical data with at least one predetermined threshold for each of said domains.

The computer-readable medium can include any suitable medium such as, but not limited to, floppy discs, hard discs, CD-ROMS, flash memory, non-volatile ROM and RAM.

An embodiment of the invention provides an efficient solution to the problem of management of the system for traceability of industrial products on a production site.

An embodiment of the invention provides a technique for making an expertise on the exhaustiveness, effectiveness and reliability of the traceability system on an industrial site that is efficient and simple to implement.

An embodiment of the invention proposes such a technique that can be used on any production site.

An embodiment of the invention provides such a technique capable of deleting or at least very significantly reducing the risk of failure in terms of time in the identification process and withdrawal of all products that could be defective or that generate a risk for the safety or health of users.

An embodiment of the invention proposes such a technique that the enterprise managing the site could use to restructure and improve its traceability system while controlling the corresponding investment costs.

An embodiment of the invention enables setting up a recognised certification confirming the organisational quality of the set of facilities dealing with traceability for an industrial production site.

Although the present disclosure has been described with reference to preferred embodiments, workers skilled in the art will recognize that changes may be made in form and detail without departing from the spirit and scope of the invention.

What is claimed is:

1. Method for inspection of the quality of products produced by a production system, by monitoring the exhaustiveness, effectiveness and reliability of a traceability system associated with said production system, the method comprising:
determination of a plurality of domains of said traceability system to be inspected;
determination of a plurality of criteria to be monitored for each of said domains, said criteria for a domain being correlated to each other;
for each of said criteria, assignment of a numerical data representing a quality value by measurement through at least one sensor and/or by assessment;
for each of said domains, multiplication of all said numerical data for each of said criteria of said domain and application of a mathematical regression function to the resulting product to obtain a numerical data representative of a quality value of said domain; and
comparison of said numerical data with at least one predetermined threshold for each of said domains.

2. Method according to claim 1 and further comprising generating a graphic representation of said numerical data for each of said domains in the form of a rosette.

3. Method according to claim 2, wherein said regression function is chosen such that said predetermined threshold coincides with the mid-point of a corresponding branch of said rosette.

4. Method according to claim 2 and further comprising comparing said generated rosette with a minimum predetermined rosette and, depending on the result of said comparison, a step to issue a certification label for said traceability system.

5. Method according to claim 1, wherein said domains of said traceability system belong to the group comprising:
quality of information necessary to produce a complete map-making of the activity of said production system;
exhaustiveness of information related to said traceability system;
matching of said traceability system and operating processes of said production system;
assessment of the reliability of said traceability system;
coding of said products conforming with at least one coding standard applicable to said production system;
availability of information and products;
matching of said traceability system and at least one risk management use related to an activity sector of said production system;
extension of said traceability system outside said production system within an activity-network scope; and
setting up in said production system of at least one traceability procedure and at least one training plan in said procedure for said production system personnel.

6. Method according to claim 1, wherein said step to assign a numerical data to each of said criteria is done following a matrix analysis of said traceability system, and said numerical data assigned to each of said criteria is a value from a set of four predetermined numerical constants depending on whether said criterion is:
conforming with a predetermined reference criterion;
not conforming with said predetermined reference criterion and with high importance;
not conforming with said predetermined reference criterion and with moderate importance;
not conforming with said predetermined reference criterion and with low importance.

7. Method according to claim 6, wherein said numerical constants are within the set (1; 0.01; 0.7; 0.9).

8. Method according to claim 1, wherein for a domain, the said predetermined threshold, represented by variable S is defined by S=ƒ_{p,q}(β^{p}γ^{q}), where p is the number of criteria with moderate importance in said domain, q is the number of criteria with low importance in said domain, ƒ_{p,q} is said mathematical regression function, β is the value of the numerical data assigned to a moderate importance criterion, and γ is the value of the numerical data assigned to a low importance criterion.

9. Method according to claim 8, wherein α is the value of the numerical data assigned to a high importance criterion, the highest numerical value such that 0<α<β<γ<1 and α<β^{p}γ^{q} for all values β and γ is assigned to α.

10. Method according to claim 8, wherein application of said mathematical regression function ƒ_{p,q} to 1 corresponds to a predetermined scale factor, and to β^{p}γ^{q} corresponds 1 to half of said scale factor.

11. Method according to claim 10, wherein said scale factor is approximately equal to 100.

12. Method according to claim 3, wherein only high importance criteria are considered during said comparison step between said generated rosette and a predetermined minimum rosette.

13. Quality control system for products produced by a production system by monitoring the exhaustiveness, effectiveness and reliability of a traceability system associated with said production system, the quality control system comprising means for:
determining a plurality of domains of said traceability system to be controlled;
determining a plurality of criteria to be monitored for each of said domains, said criteria for a domain being correlated to each other;
for each of said criteria, assignment of a numerical data representing a quality value by measurement through at least one sensor and/or by assessment;
for each of said domains, multiplication of all numerical data for each of said criteria in said domain and application of a mathematical regression function to the resulting product to obtain a numerical data representing a quality value for said domain;
for each said domain, comparison of said numerical data with at least one predetermined threshold.

14. Computer software comprising program code instructions for performing a method for inspection of the quality of products produced by a production system, by monitoring a traceability system associated with said production system, the method comprising:
determination of a plurality of domains of said traceability system to be inspected;
determination of a plurality of criteria to be monitored for each of said domains, said criteria for a domain being correlated to each other;
for each of said criteria, assignment of a numerical data representing a quality value by measurement through at least one sensor and/or by assessment;
for each of said domains, multiplication of all said numerical data for each of said criteria of said domain and application of a mathematical regression function to the resulting product to obtain a numerical data representative of a quality value of said domain; and
comparison of said numerical data with at least one predetermined threshold for each of said domains.
